(19) United States
(12) Patent Application Publication
(10) Pub. No.: US 2005/0026593 A1
(43) Pub. Date: Feb. 3, 2005

(54) Accessing public printers from mobile electronic devices

(76) Inventors: Jeff M. Anderson, Camas, WA (US); Jeremy Bunn, Kelso, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/629,076

(22) Filed: Jul. 29, 2003

(51) Int. Cl. H04M 1/66

(52) U.S. Cl. 455/410; 455/352; 455/414.1

(57) ABSTRACT

Apparatus and methods for providing print services for a mobile electronic device are provided. A method includes receiving an access code. The access code is for granting the mobile electronic device access to a publicly accessible printer via a print service. The method also includes collecting a first fee from a user of the mobile electronic device in exchange for the access code.

### FIELD OF THE INVENTION

The present invention relates generally to printing from mobile electronic devices.

### BACKGROUND

Mobile electronic devices, such as mobile phones, hand-held personal computers, e.g., personal digital assistants, etc. are normally incapable of converting data into a printer-ready format required by many printers for printing. Therefore, in order to print data from many mobile electronic devices, the data is transferred to a network device (or server), e.g., via a wireless connection, that converts the data into a printer-usable format. The server then sends the converted data to a printer to be printed. However, this method of printing is typically restricted to a limited number of users, such as employees of a company, e.g., via the company's intranet, and is not readily available for public use.

For the reasons stated above, and for other reasons stated below that will become apparent to those skilled in the art upon reading and understanding the present specification, there is a need in the art for alternatives for printing from mobile electronic devices.

### SUMMARY

One embodiment of the present invention provides a method of providing print services for a mobile electronic device. The method includes receiving an access code. The access code is for granting the mobile electronic device access to a publicly accessible printer via a print service. The method also includes collecting a first fee from a user of the mobile electronic device in exchange for the access code.

### DESCRIPTION OF THE DRAWINGS

FIG. 1 is a block diagram of a system for printing data of a mobile electronic device according to an embodiment of the present invention.

FIG. 2 is a flowchart of a method of operating a print service according to another embodiment of the present invention.

FIG. 3 is a flowchart of a method of operating a point-of-sale device according to another embodiment of the present invention.

FIG. 4 is a flowchart of a method of operating a point-of-sale device according to yet another embodiment of the present invention.

FIG. 5 is a flowchart of a method for printing data from mobile electronic device according to an embodiment of the present invention.

### DETAILED DESCRIPTION

In the following detailed description of the present embodiments, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that process, electrical or mechanical changes may be made without departing from the scope of the present invention. The following detailed description is, therefore, not to be taken in a limiting sense, and the scope of the present invention is defined only by the appended claims and equivalents thereof.

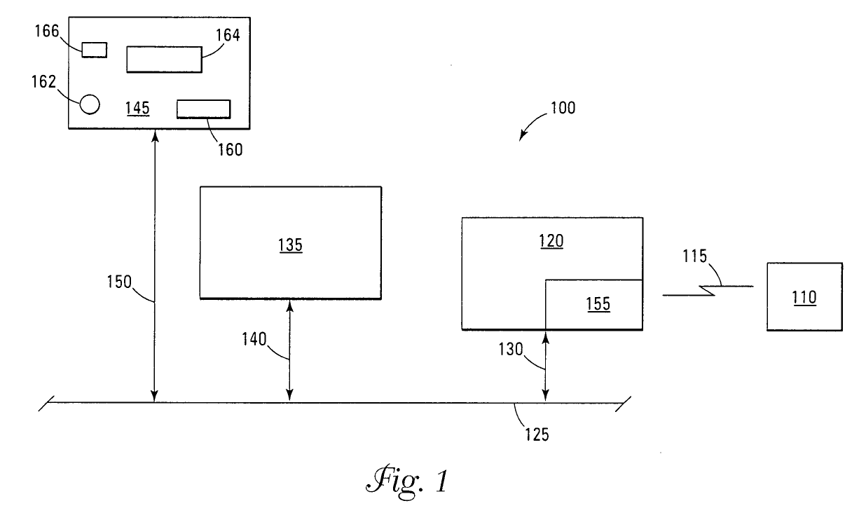

FIG. 1 is a block diagram of a system 100 for printing data of a mobile electronic device 110 according to an embodiment of the present invention. For one embodiment, mobile electronic device 110 is a mobile telephone, a wireless hand-held personal computer, such as a Jornada handheld PC manufactured by the Hewlett-Packard Company, Palo Alto, Calif., U.S.A. or a BLACKBERRY handheld unit manufactured by Research In Motion Limited, Waterloo, Canada, etc. For another embodiment, a wireless interface 115, e.g., an IEEE 802.11 interface, communicatively couples mobile electronic device 110 to a print service 120. For one embodiment, print service 120 is a mobile-telephone carrier, such as AT&T, MCI, SPRINT, T-MOBILE, or the like. For another embodiment, print service 120 is a network server, such as an Internet server. For one embodiment, print service 120 is connected to a data network 125, such as the Internet, by an interface 130.

A printer 135 is connected to network 125 by an interface 140. For one embodiment, printer 135 is publicly accessible. For example, printer 135 is located in a place of business open to the public, such as a coffee shop, library, bookstore, copy shop, etc. A point-of-sale device 145, such as a point-of-sale (or checkout or sales) terminal, is connected to network 125 by an interface 150. For one embodiment, point-of-sale device 145 is used in selling printing rights (or access) to printer 135. For another embodiment, point-of-sale device 145 is located in the place of business and is used in the sale of goods and/or services of the place of business and in selling printing rights to printer 135. For another embodiment, a proprietor of printer 135 is the proprietor of point-of-sale device 145 and the place of business. For one embodiment, point-of-sale device 145 is configured for operation by a customer of the proprietor, such as the user of mobile electronic device 110 for purchasing access to printer 135.

For another embodiment, mobile electronic device 110 includes software, such as, “HP mobile printing for pocket pc” available from the Hewlett-Packard Company, Palo Alto, Calif., U.S.A., that enables mobile electronic device 110 to communicate with print service 120. For example, the software creates print requests that are in a format that can be interpreted by print service 120 and sends the print requests to print service 120.

For one embodiment, print service 120 includes a computer-usable storage media 155 that can be fixedly or removably attached to print service 120. Some examples of computer-usable media include static or dynamic random access memory (SRAM or DRAM), read-only memory (ROM), electrically-erasable programmable ROM (EEPROM or flash memory), magnetic media and optical media, whether permanent or removable. For one embodiment, computer-usable storage media 155 includes computer-usable instructions, e.g., including one or more printer drivers, for causing print service 120 to convert data received from mobile electronic device 110 into printer-usable data and to send the printer-usable data to printer 135 over network 125 for printing. For one embodiment, the computer-usable instructions of print service 120 include “HP mobile enterprise printing solution” software available from the Hewlett-Packard Company, Palo Alto, Calif., U.S.A.

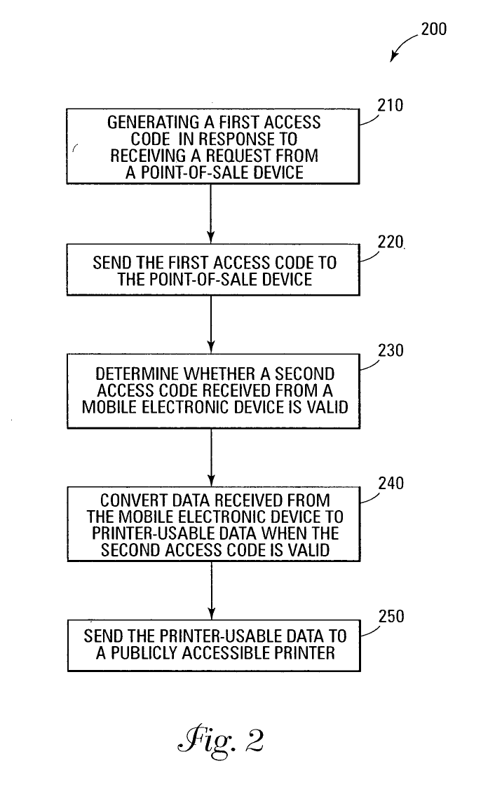

For one embodiment, the computer-readable instructions are adapted to cause print service 120 to perform a method 200, as illustrated by the flowchart of FIG. 2. At block 210, print service 120 generates a first access code in response to receiving a request from point-of-sale device 145. The first access code corresponds to a print job that for one embodiment includes printer-usable data converted from data of mobile electronic device 110 at print service 120. The first access code enables a user of mobile electronic device 110 to access printer 135 via print service 120 for executing the print job on printer 135. The first access code may be one or more numbers or letters or may be alphanumeric.

For one embodiment, the print job includes one or more access parameters included in the request from point-of-sale device 145, such as one or more printing options, e.g., a limit to a number of pages that can be printed, color, grayscale, etc. For another embodiment, the access parameters include an address of printer 135 that is included in the request from point-of-sale device 145, such as a network address. For some embodiments, print service 120 generates the first access code by assigning one or more characters of the access code to each of the access parameters. For other embodiments, print service 120 registers the first access code by storing the access code. At block 220, the first access code is sent to point-of-sale device 145.

Print service 120 determines whether a second access code received from mobile electronic device 110 is valid at block 230. For one embodiment, this involves comparing the second access code to the first access code. For another embodiment, when the second access code matches the first access code, the second access code is valid, and mobile electronic device 110 is given access to printer 135 and is granted the printing options associated with the first access code stored in print service 120. For one embodiment, print service 120 sends a message to the user of mobile electronic device 110 that prompts the user to send the second access code. For another embodiment, when the second access code is invalid (e.g., the first and second access codes do not match), mobile electronic device 110 is denied access to printer 135, and for other embodiments, print service 120 sends a message to mobile electronic device 110 indicating an invalid access code. For other embodiments, the second access code is generated by print service 120, sent to point-of-sale device 145, and given to the user of mobile electronic device 110, e.g., in exchange for a fee paid to the proprietor of printer 135.

At block 240, print service 120 converts data received from mobile electronic device 110 into to printer-usable data when the second access code is valid. Then, at block 250, print service sends the printer-usable data to printer 135. For one embodiment, print service 120 sends the print job corresponding to the first access code, e.g., including the printing options and the printer-usable data, to printer 135.

For another embodiment, print service 120 invalidates the first access code after determining that the second access code is valid. This prevents the second access code from being reused. For some embodiments, invalidating the first access code involves deleting the first access code from print service 120. Therefore, for various embodiments, if print service 120 receives the second access code again, the second access code cannot be matched to the first access code because the first access code has been deleted. For one embodiment, the first access code is invalidated after print service sends the print job to printer 135, for example, after print service 120 receives confirmation from printer 135 that the printer-usable data has been printed.

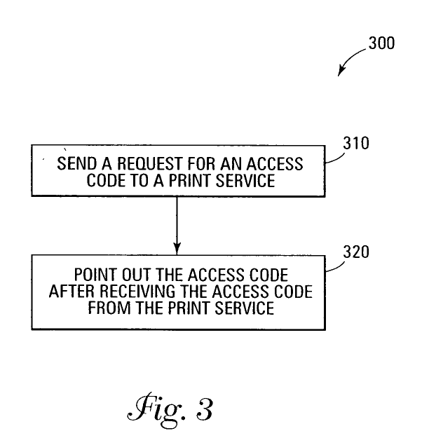

For one embodiment, point-of-sale device 145 includes a computer-usable storage media 160 that can be fixedly or removably attached to point-of-sale device 145. For another embodiment, computer-usable storage media 160 contains computer-readable instructions for causing point-of-sale device 145 to perform various methods, such as a method 300 illustrated by the flowchart in FIG. 3.

At block 310, point-of-sale device 145 sends a request for an access code, such as the first access code described above, from print service 120 in response to receiving inputs from a user of point-of-sale device 145. For various embodiments, the user of point-of-sale device 145 is the proprietor of printer 135 or is acting on behalf of the proprietor of printer 135, such as an employee of the proprietor or a customer of the proprietor for embodiments where point-of-sale device is configured for customer operation, etc. For one embodiment, the request is sent in response to the user activating a button 162 of point-of-sale device 145. For another embodiment, the request is sent in response to the user selecting one or more icons (not shown) of a display 164 of point-of-sale device 145. For another embodiment, display 164 prompts the user to input the access parameters described above. For one embodiment, display 164 displays the access parameters for selection by the user. For another embodiment, the user is prompted to send the request to print service 120. For example, the user is prompted to select an icon of display 164, activate button 162, etc. At block 320, a printer 166 of point-of-sale device 145 prints out the access code after point-of-sale device 145 receives the access code from print service 120 as a data signal.

For some embodiments, point-of-sale device 145 assigns a fee to the access code, e.g., based on the printing options. For one embodiment, the proprietor of printer 135 predetermines the fee. For another embodiment, point-of-sale device 145 prints out the access code upon confirmation of receipt of the fee. The confirmation may be the result of scanning a credit, check card, cash or the like into point-of-sale device 145, the user of point-of-sale device 145 indicating receipt of a check or cash, completion of a check verification, etc.

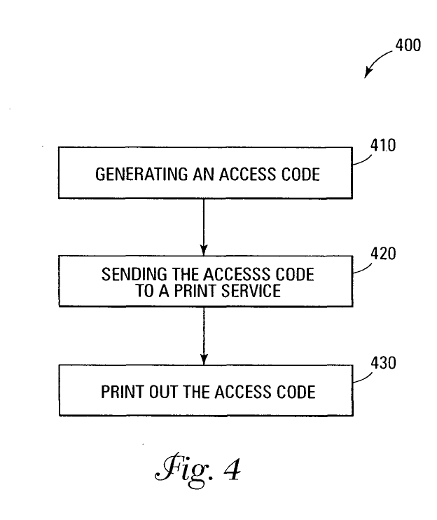

For another embodiment, point-of-sale device 145 performs a method 400, as shown in the flowchart of FIG. 4. At block 410, point-of-sale device 145 generates an access code in response to receiving inputs from the user of point-of-sale device 145. For one embodiment, the access code is generated in response to the user activating a button 162 of point-of-sale device 145. For another embodiment, the access code is generated in response to the user selecting one or more icons of a display 164 of point-of-sale device 145. For another embodiment, display 164 prompts the user to input the access parameters described above before point-of-sale device 145 generates the access code. For one embodiment, display 164 displays the access parameters for selection by the user before point-of-sale device 145 generates the access code. For another embodiment, point-of-sale device 145 generates the access code by assigning each of the access parameters to one or more access-code characters. For another embodiment, the user is prompted to send the access code to print service 120. For example, the user is prompted to select an icon of display 164, activate button 162, etc.

At block 420, point-of-sale device 145 sends the access code to print service 120 for registering the access code with the print service. At block 430, point-of-sale device 145 prints out the access code. For one embodiment, the access code is printed out when point-of-sale device 145 receives a message from print service 120 indicating receipt of the access code at print service 120. For another embodiment, print service 120 registers the access code by linking one or more characters of the access code to the access parameters and storing the access code. For this embodiment, the access code is printed out when point-of-sale device 145 receives a message from print service 120 indicating registration of the access code at print service 120.

For one embodiment, the proprietor of printer 135 establishes a first fee for the access code. For another embodiment, the proprietor of printer 135 sells the printed access code to a user of mobile electronic device 110 in exchange for the first fee. For some embodiments, the proprietor of printer 135 pays a second fee to a proprietor of print service 120 in exchange for the above print services, such as converting the data of mobile electronic device into printer-usable data, processing the print request from mobile electronic device 110, providing the access code, handling of the access code, e.g., receiving the access code from point-of-sale device 145, registering the access code, and invalidating the access code, etc.

For another embodiment, the first fee is based on the print job corresponding to the access code, the second fee, and, for example, costs for maintaining operation of printer 135, such as ink or toner costs, a profit margin, etc. For other embodiments, the user of mobile electronic device 110 pays the second fee to the proprietor of print service 120 for the above print services. For one embodiment, the user of mobile electronic device 110 pays a portion of the second fee, e.g., the portion for converting the data of mobile electronic device into printer-usable data, processing the print request from mobile electronic device 110, etc.

For another embodiment, the proprietor of printer 135 purchases a number of preprinted access codes that are registered with and are generated and printed by the print service 120 from the proprietor of print service 120 for a first fee. In this embodiment, the proprietor of printer 135 sells the preprinted access codes to the user of mobile electronic device 110 for a second fee that may cover the first fee, costs for maintaining operation of printer 135, such as ink or toner costs, a profit margin, etc.

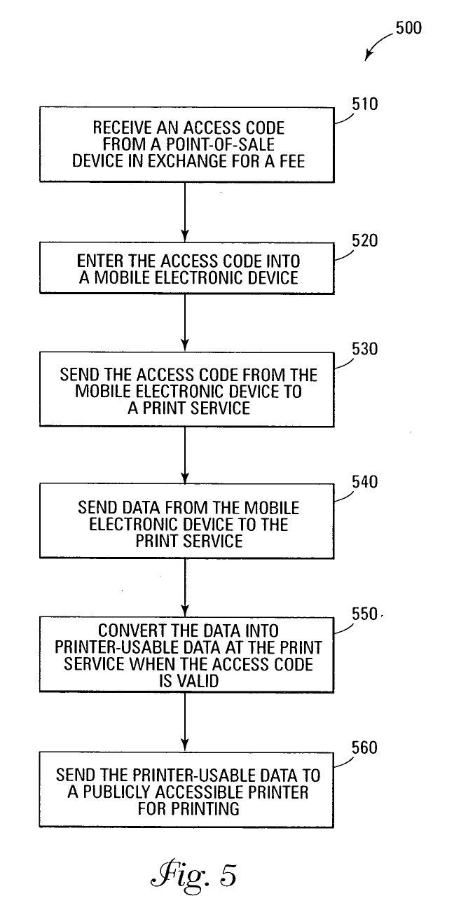

FIG. 5 is a flow chart of a method 500 for printing data from mobile electronic device 110 according to an embodiment of the present invention. At block 510 a user of mobile electronic device 110 receives an access code from point-of-sale device 145 in exchange for a fee paid to the proprietor of printer 135. The user enters the access code into mobile electronic device 110 at block 520, e.g., using a keypad of mobile electronic device 110. The access code is sent from mobile electronic device 110 to print service 120 at block 530. Data is sent to print service 120 at block 540. For one embodiment, the data is sent to print service 120 at the same time as the access code. At block 550, the data received at print service 120 from mobile electronic device 110 is converted into printer-usable data at print service 120 when the access code is valid. For one embodiment, the access code is validated as describe above. The printer-usable data is sent from the print server 120 to printer 135 for printing at block 560.

### CONCLUSION

Although specific embodiments have been illustrated and described herein, it will be appreciated by those of ordinary skill in the art that any arrangement that is calculated to achieve the same purpose may be substituted for the specific embodiments shown. Many adaptations of the invention will be apparent to those of ordinary skill in the art. Accordingly, this application is intended to cover any adaptations or variations of the invention. It is manifestly intended that this invention be limited only by the following claims and equivalents thereof.

1. A method of providing print services for a mobile electronic device, the method comprising:
receiving an access code, wherein the access code is for granting the mobile electronic device access to a publicly accessible printer via a print service; and
collecting a first fee from a user of the mobile electronic device in exchange for the access code.

2. The method of claim 1, wherein receiving the access code comprises generating the access code at a point-of-sale device and printing the access code at the point-of-sale device.

3. The method of claim 1, wherein receiving the access code comprises receiving the access code from the print service at a point-of-sale device and printing the access code at the point-of-sale device.

4. The method of claim 1, further comprising sending a request for the access code to the print service using a point-of-sale device before receiving the access code.

5. The method of claim 4, wherein sending the request for the access code to the print service comprises sending at least one of at least one printing option and an address of the printer to the print service.

6. The method of claim 1, wherein receiving an access code comprises receiving a preprinted access code from the print service.

7. A method of providing print services for a mobile electronic device, the method comprising:
generating an access code at a point-of-sale device by assigning one or more characters of the access code to an access parameter comprising at least one of at least one printing option and an address of a publicly accessible printer, wherein the access code is for granting the mobile electronic device access to the printer via a print service;
sending the access code to a print service for registering the access code with the print service;
printing the access code at the point-of-sale device; and
collecting a first fee from a user of the mobile electronic device in exchange for the printed access code.

8. A method of operating a point-of-sale device, the method comprising:
generating an access code by assigning one or more characters of the access code to an access parameter comprising at least one of at least one printing option and an address of a publicly accessible printer, wherein the access code is for granting a mobile electronic device access to the printer via a print service;
sending the access code to the print service; and
printing the access code.

9. The method of claim 8, further comprising prompting a user of the point-of-sale device to input the access parameter before generating the access code.

10. A method of operating a point-of-sale device, the method comprising:
sending a request for an access code to a print service, wherein the access code is for granting a mobile electronic device access to a publicly accessible printer via the print service;
receiving the access code from the print service; and
printing the access code.

11. The method of claim 10, wherein sending the request for the access code to the print service comprises sending an access parameter to the print service, the access parameter comprising at least one of at least one printing option and an address of the printer.

12. The method of claim 10, further comprising assigning a fee to the access code.

13. A method for operating a print service, the method comprising:
in response to receiving a request from a point-of-sale device, generating a first access code by assigning one or more characters of the first access code to an access parameter comprising at least one of at least one printing option and an address of a publicly accessible printer, wherein the first access code is for granting a mobile electronic device access to the printer via the print service;
sending the first access code to the point-of-sale device; and
storing the first access code at the print service.

14. The method of claim 13, further comprising determining whether a second access code received from the mobile electronic device is valid.

15. The method of claim 14, wherein determining whether the second access code is valid comprises comparing the first and second access codes.

16. The method of claim 14, further comprising converting data received from the mobile electronic device to printer-usable data when the second access code is valid.

17. The method of claim 16, further comprising sending the printer-usable data to the printer.

18. The method of claim 14, further comprising invalidating the first access code after determining that the second access code is valid.

19. A method for operating a print service, the method comprising:
in response to receiving a request from a point-of-sale device, generating a first access code by assigning one or more characters of the first access code to an access parameter comprising at least one of at least one printing option and an address of a publicly accessible printer, wherein the first access code is for granting a mobile electronic device access to the printer via the print service;
sending the first access code to the point-of-sale device;
determining whether a second access code received from the mobile electronic device is valid;
converting data received from the mobile electronic device to printer-usable data when the second access code is valid;
invalidating the first access code after determining that the second access code is valid; and
sending the printer-usable data to the printer.

20. A method for operating a print service, the method comprising:
comparing a first access code received from a point-of-sale device to a second access code received from a mobile electronic device;
converting data received from the mobile electronic device to printer-usable data when the second access code matches the first access code;
sending the printer-usable data to a publicly accessible printer; and
invalidating the first access code.

21. A computer-usable storage media containing computer readable instructions for causing a point-of-sale device to perform a method, the method comprising:
generating an access code by assigning one or more characters of the access code to an access parameter comprising at least one of at least one printing option and an address of a publicly accessible printer, wherein the access code is for granting a mobile electronic device access to the printer via a print service;
sending the access code to the print service; and
printing the access code.

22. A computer-usable storage media containing computer readable instructions for causing a point-of-sale device to perform a method, the method comprising:
sending a request for an access code to a print service, wherein the access code is for granting a mobile electronic device access to a publicly accessible printer via the print service; and
receiving the access code from the print service; and
printing the access code.

23. A computer-usable storage media containing computer readable instructions for causing a print service to perform a method, the method comprising:
in response to receiving a request from a point-of-sale device, generating a first access code by assigning one or more characters of the first access code to an access parameter comprising at least one of at least one printing option and an address of a publicly accessible printer, wherein the first access code is for granting a mobile electronic device access to the printer via the print service;
sending the first access code to the point-of-sale device; and
storing the first access code at the print service.

24. The computer-usable storage media of claim 23, wherein the method further comprises determining whether a second access code received from a mobile electronic device is valid.

25. The computer-usable storage media of claim 24, wherein the method further comprises converting data received from the mobile electronic device into to printer-usable data when the second access code is valid.

26. The computer-usable storage media of claim 25, wherein the method further comprises sending the printer-usable data to the printer.

27. The computer-usable storage media of claim 24, wherein the method further comprises invalidating the first access code after determining that the second access code is valid.

28. A computer-usable storage media containing computer readable instructions for causing a print service to perform a method, the method comprising:
comparing a first access code received from a point-of-sale device to a second access code received from a mobile electronic device;
converting data received from the mobile electronic device to printer-usable data when the second access code matches the first access code;
sending the printer-usable data to a publicly accessible printer; and
invalidating the first access code.

29. A point-of-sale device comprising:
means for generating an access code by assigning one or more characters of the access code to an access parameter comprising at least one of at least one printing option and an address of a publicly accessible printer, wherein the access code is for granting a mobile electronic device access to the printer via a print service;
means for sending the access code to the print service; and
means for printing the access code.

30. A point-of-sale device comprising:
means for sending a request for an access code to a print service, wherein the access code is for granting a mobile electronic device access to a publicly accessible printer via the print service; and
means for receiving the access code from the print service; and
means for printing the access code.

31. A print service comprising:
means for generating a first access code by assigning one or more characters of the first access code to an access parameter comprising at least one of at least one printing option and an address of a publicly accessible printer, wherein the first access code is for granting a mobile electronic device access to the printer via the print service;
means for sending the first access code to a point-of-sale device;
means for determining whether a second access code received from the mobile electronic device is valid;
means for converting data received from the mobile electronic device to printer-usable data when the second access code is valid;
means for invalidating the first access code after determining that the second access code is valid; and
means for sending the printer-usable data to the printer.

32. A print service comprising:
means for comparing a first access code received from a point-of-sale device to a second access code received from a mobile electronic device;
means for converting data received from the mobile electronic device to printer-usable data when the second access code matches the first access code;
means for sending the printer-usable data to a publicly accessible printer; and
means for invalidating the first access code.
